(19) United States
(12) Patent Application Publication
(10) Pub. No.: US 2026/0319144 A1
(43) Pub. Date: Oct. 15, 2026

(54) PASSIVE THERMAL COMPENSATION LENS

(71) Applicant: Snap Inc., Santa Monica, CA (US)

(72) Inventors: David Nicholas Crosby, Oxford (GB); Thomas Norman Llyn Jacoby, Woodstock (GB); David Mark Woods, Wantage (GB)

(21) Appl. No.: 19/578,441

(22) Filed: Mar. 25, 2026

Related U.S. Application Data
(60) Provisional application No. 63/789,131, filed on Apr. 15, 2025.

(51) Int. Cl. G02B 3/14; G02B 3/00; G03B 21/14

(52) U.S. Cl. CPC G02B 3/14; G02B 3/0081; G03B 21/142

(57) ABSTRACT

A passively athermalized optical assembly comprises an expanding lens having an optical power that becomes more positive when a temperature of the optical assembly increases from a first temperature to a second temperature. The more positive optical power of the expanding lens complements changes in other components of the optical assembly such that an outgoing light bundle maintains a propagation trajectory when the temperature of the optical assembly changes from the first temperature to the second temperature.

### CLAIM OF PRIORITY

This application claims the benefit of priority to U.S. Provisional Application Ser. No. 63/789,131, filed on Apr. 15, 2025, which is incorporated herein by reference in its entirety.

### TECHNICAL FIELD

The present disclosures relate to optical systems and, in some examples, to passive thermal compensation to maintain optical performance across varying temperatures.

### BACKGROUND

A lens whose optical power increases with temperature may be used to correct another optical system whose optical power decreases with temperature. The lens changes power with temperature due to its design and materials without any electronic or other control. Examples include a fluid filled lens where the fluid has a larger coefficient of thermal expansion than an enclosure (having the lower coefficient of thermal expansion). At increased temperature above ambient, the fluid expands into a deformable membrane which decreases the radius of curvature of the membrane, corresponding to an increase in optical power.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is an illustration of optical power change in a lens with temperature, according to some examples.

FIG. 2 is a schematic of an axisymmetric athermalizing lens, according to some examples.

FIG. 3 is a schematic of an axisymmetric athermalizing lens, according to some examples.

FIG. 4 is a diagram showing principle of operation for an athermal lens having a deformable membrane, according to some examples.

FIG. 5 is a graph of optical power varying with temperature, according to some examples.

FIG. 6 is a diagram of a measurement of optical power change with temperature for an athermal lens, according to some examples.

FIG. 7 is diagram of another membrane-based athermal lens, according to some examples.

FIG. 8 is a diagram of a double sided membrane athermal lens, according to some examples.

FIG. 9 is a diagram of a double sided membrane athermal lens at an increased temperature, according to some examples.

FIG. 10A is a diagram of a constrained lens, according to some examples.

FIG. 10B is a side view of a diagram of a constrained lens at varying temperatures, according to some examples.

FIG. 11 is a flowchart showing operations of an example method for an athermalizing lens, according to some examples.

### DETAILED DESCRIPTION

Optical systems may use plastic optical elements (e.g., lenses) which may be lighter and cheaper to mass produce than glass lenses. Additionally, plastic optical elements may be molded to tight dimensional tolerances in arbitrary “free-form” shapes which gives optical designers greater freedom to optimize for optical aberrations, size, weight, etc. Plastic materials, however, tend to have larger coefficients of thermal expansion, α_{L}, than glass as well as larger rates of change of optical index of refraction with temperature, (dn/dT).

In some examples, an optical performance of an optical system using plastic optics may be impacted more with temperature than a corresponding optical system using glass optics. For instance, a micro-projector containing glass elements housed in a low coefficient of thermal expansion (CTE) housing may change power by around −0.001 or −0.002 diopters per ° C., giving a −0.05 diopter change under a +25° C. change use case. In an equivalent design using plastic elements, the power change may be approximately −0.005 to −0.01 diopters per ° C., which may degrade the optical performance.

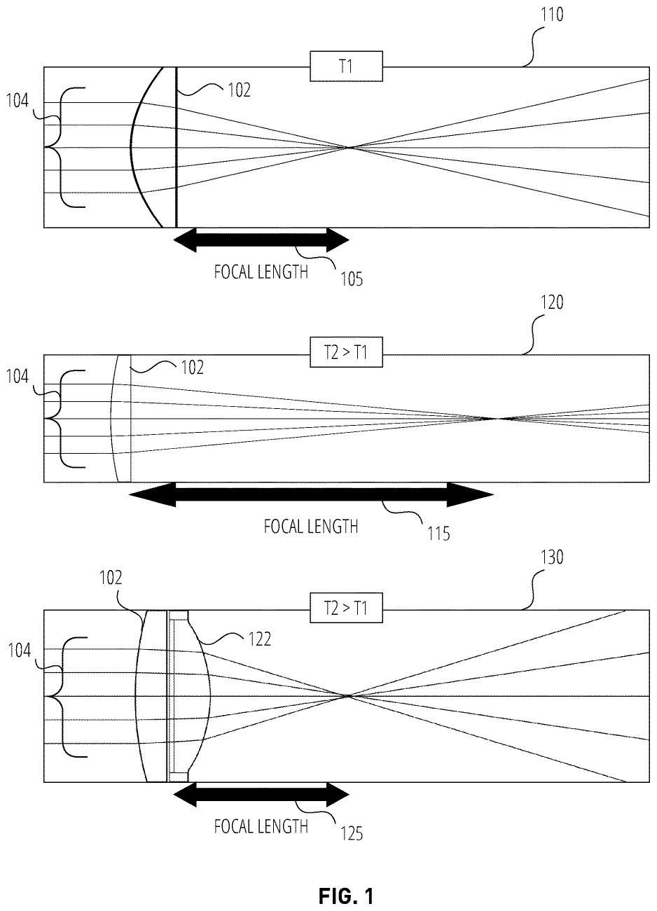

FIG. 1 shows an illustration of optical power change in a lens with temperature, according to some examples. Raytracing diagram 110 shows an optical system 102 (simplified to a plano-convex lens) having a focal length 105 as shown by the input rays 104 propagating through the optical system 102. The optical power Φ may be related to the inverse of the focal length 105. The optical power, Φ, of a surface of radius of curvature R is

Φ=(n−1)/R

where n is the refractive index of the material at the boundary of the material and air. Plastic and glass lens materials typically expand on heating, with a linear coefficient of thermal expansion (CTE) α_{L}>0, and the refractive indices of the materials decrease

$$( \frac{d n}{d T} < 0 ) .$$

A mechanically unconstrained biconvex lens, as shown in optical system 102, that warms up may get larger: its radii of curvature (on one or both surfaces) may increase and its refractive index goes down, both of which contribute to its power decreasing. The increase in temperature of the system is shown in raytracing diagram 120, where the focal length 115 of the optical system 102 has also increased as the radius of curvature increases, corresponding to a decrease in the optical power Φ. The actual power change of an optical system (e.g., comprising lenses and other optical elements) depends on the optical design and materials used in the optical system. For example, in addition to the optical material change (e.g., dn/dT and geometric expansion), stress and strain of the housing materials and exact mounting configurations (e.g., glue, cement, other adhesives) for the optical elements within the system. In general, optical systems tend to decrease in optical power as the temperature increases.

Note that, for optical systems such as a mechanically unconstrainted biconcave lens (or other such optical element that creates a diverging beam, such as a negative meniscus lens, plano-concave lens, any suitable combination, etc.) that have a negative focal length, the optical power may be a negative quantity. When a mechanically unconstrained biconcave lens warms up, it may get larger: its radii of curvature (on one or both surfaces) may increase and its refractive index may go down, both of which may contribute to an absolute value of its power decreasing. That is, an optical system that has a negative optical power may weaken and may have a more positive optical power at an increased temperature. This is due to the optical power being a signed quantity and is conceptually congruent with the description of an unconstrained biconvex lens as shown in optical system 102.

Throughout this specification, any references to an optical power may be considered as a signed quantity or an absolute value quantity based on the context of the optical power. For example, a statement that optical power ‘increases’ may refer to an increase in the absolute magnitude of the optical power, such as by a change in material selection that impacts the index of refraction, or to the optical power becoming more positive, (e.g., a negative value of −2 diopters becomes −1 diopters), such as by a change in radius of curvature of one or more surfaces of the lens.

An athermalizing lens 122 may be added to the optical system 102, such that the focal length 125 at the increased temperature is approximately the same as the focal length 105. In some examples, the combined system of the optical system 102 and athermalizing lens 122 may have approximately the same optical power (e.g., focal length 105) across a range of temperatures.

Note that the raytracing diagram 110, 120, and 130 show examples of an input beam that is collimated (e.g., on the left-hand side of the optical system 102) and forms an image (e.g., focuses on the right-hand side of the optical system 102). In practice, any suitable input beam may be used with the optical system 102 and the athermalizing lens 122. In some examples, a diverging beam may be input in order to be collimated by the optical system 102 and the athermalizing lens 122. In some examples, the athermalizing lens 122 may have an optical power that allows the light (e.g., a ray bundle, etc.) input to the optical system 102 (combined with the athermalizing lens 122) to have an approximately identical trajectory outgoing (e.g., collimated, converging, diverging, at any suitable focal length) from the combined optical system 102 and athermalizing lens 122 across a range of temperatures.

The described examples introduce an expanding lens with optical power that becomes more positive when temperature increases. This expanding lens complements the negative power changes in other components of the optical assembly, maintaining consistent optical performance across temperature variations.

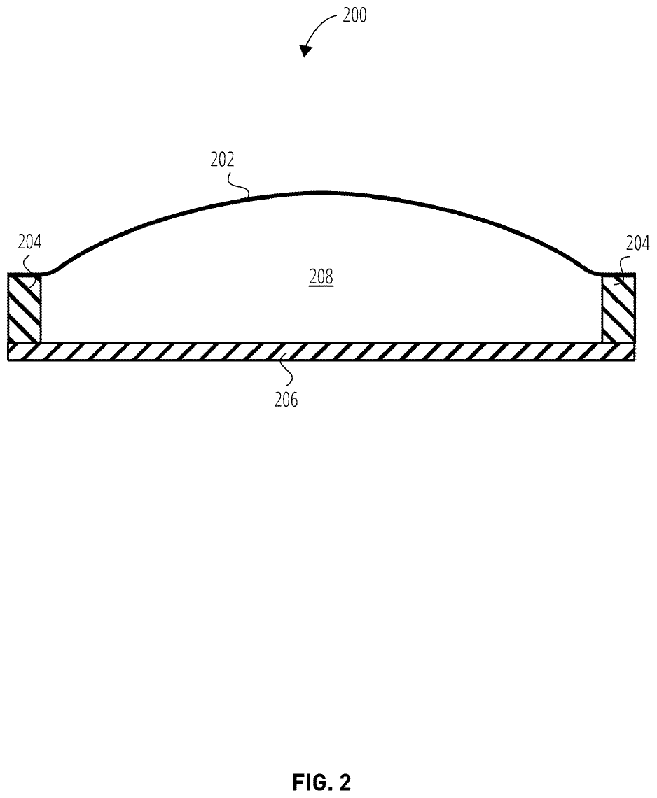

FIG. 2 is a schematic of an axisymmetric athermalizing lens 200. The athermalizing lens 200 comprises an enclosure defined by at least one thin deformable element (hereinafter, membrane 202), a rigid exterior 204, a transparent element 206, with the enclosure filled with an optical fluid 208.

The athermalizing lens 200 may have different thermal expansion rates between components by selecting materials with differing coefficients of thermal expansion (CTE). In an example, the optical fluid 208 in the athermalizing lens 200 may have a larger CTE than the enclosure material (e.g., the rigid exterior 204 and transparent element 206). When the ambient temperature increases and the athermalizing lens 200 heats up, the optical fluid 208 may expand more than the enclosure. This may cause the membrane 202 to deform and thereby increase the optical power of the athermalizing lens 200.

The membrane 202 may be any suitable flexible, deformable material that is substantially transparent at a given wavelength. For example, the membrane 202 may be a plastic film (PVC, polyethylene, etc.,) or other polymer film, a silicone rubber film, or any other suitable material. The membrane 202 may mechanically secured (e.g., using any suitable epoxy, glue, adhesive, mechanical means such as a sealant ring or gasket) to rigid exterior 204 positioned at the periphery of the membrane.

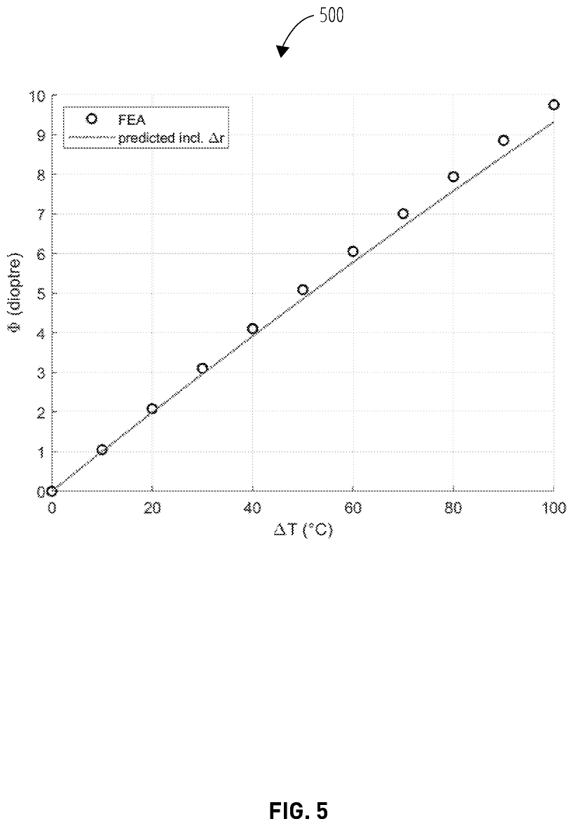

The membrane 202 may be nearly spherical in the central region, and may have a boundary at an edge (near the rigid exterior 204) where the shape and mechanical behavior of the membrane 202 is plate-like with a plate stiffness of D. The membrane 202 may have a membrane tension denoted by γ. In an example, a flat-plus-sphere approximation may be used in an analytical model (e.g., for finite element analysis, as shown in FIG. 5). The membrane shape may be approximated by a spherical section of radius α′=α−ΔR and a flat annular region of width

$$Δ r = F \sqrt{\frac{D}{γ}} ,$$

where F is an empirical fudge factor of order unity to correct for the approximation that the volume under the flat-spherical approximation may be less than that under a realistic membrane with curved boundary region.

The rigid exterior 204 may be any suitable rigid material having a cylindrical symmetry (e.g., such as a gasket shape), such as metal, glass, rubber, nylon, etc. The transparent element 206 may have any suitable material composition (e.g., glass, plastic, etc.), and may be positioned opposite the membrane 202. In an example, the transparent element 206 may be flat or curved, rigid or flexible, and uniform or non-uniform in thickness (e.g., concave or convex on one or both sides), with corresponding optical properties as a lens. The rigid exterior 204 and the transparent element 206 may be secured together to create an enclosure for optical fluid 208 using any suitable joining material such as glue, epoxy, optical cement, or the like. In an example, a mechanism used to secure the rigid exterior 204 and the transparent element 206 may allow for thermal expansion of the rigid exterior 204 and transparent element 206 over a specified temperature range (e.g., ambient to 20° C. above ambient).

The rigid exterior 204 may have a height H, and the transparent element may extend to the outside of the rigid exterior 204 with a radius α (e.g., so that the rigid exterior 204 is mounted on top of transparent element 206) in an example. In an example, the transparent element 206 may extend to the inside of the rigid exterior 204 (e.g., so that the transparent element 206 makes contact with the rigid exterior 204 on an interior surface of the cylindrical portion of the rigid exterior 204). In an example, the linear CTE for the rigid exterior 204 and for the transparent element 206 may be substantially similar and may be denoted by α₀.

The optical fluid 208 may serve as the refractive element for the athermalizing lens 200. The amount of optical fluid 208 used may provide an initial curvature to the membrane 202, such that at a reference temperature, the athermalizing lens 200 has an initial optical power.

In an example, the optical fluid 208 can be any suitable optical fluid (e.g., water, oil such as used for an oil-immersion objective) of refractive index n and linear CTE α₁. In an example, the fluid index n is a function of temperature and the wavelength of light (e.g., n(T,λ)). For a given wavelength, n(T) may decrease with temperature (e.g., dn/dT may be negative). In an example, the CTE of the optical fluid 208, α₁, may be larger than the CTE α₀ of the enclosure (e.g., rigid exterior 204 and transparent element 206). That is, to provide differential thermal expansion of the athermalizing lens 200,

α₁>α₀.

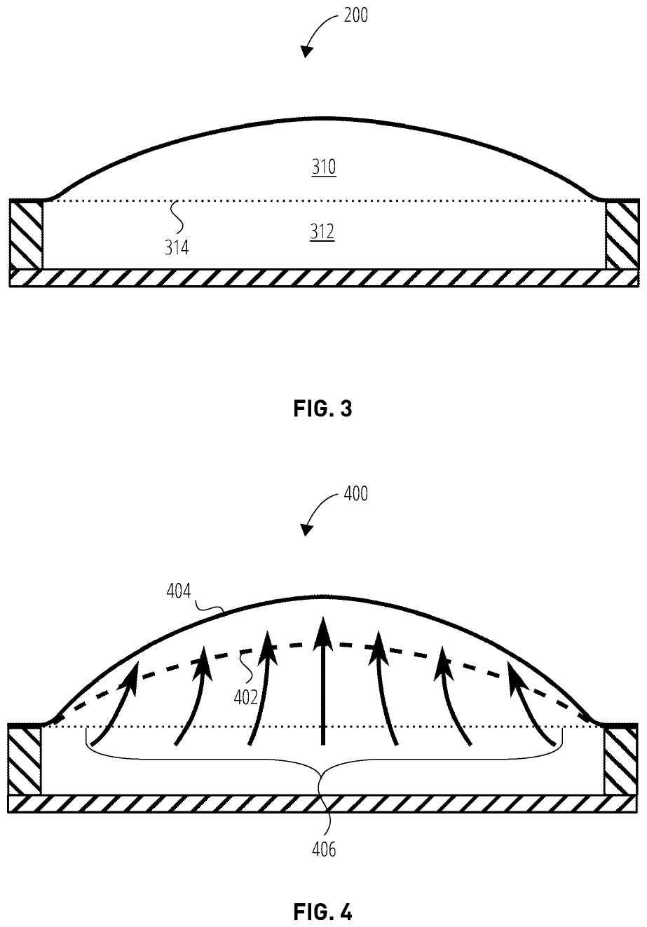

As shown in FIG. 3, the enclosure may define a fluid volume that may be considered to be two connected volumes. In an example, the rigid exterior 204 may provide a cylindrical region adjacent to a spherical cap region formed by the membrane 202. That is, one of the fluid volumes may be a substantially spherical cap 310 bounded by the membrane 202, and the second fluid volume may be a fluid reservoir region 312 bounded by rigid exterior 204.

The fluid reservoir region 312 may be a cylindrical region of height H and radius α. The fluid reservoir region 312 may be adjacent the spherical cap 310 and within the clear aperture of the lens. The spherical cap 310 and fluid reservoir region 312 may be in fluid contact as denoted by fluid connection 314, which in the example of FIG. 3 may be an imaginary boundary set at approximately the edge of the rigid exterior 204. Note that FIG. 3 may not be to scale and is given principally to show the concept of the two fluid volumes.

When the temperature of the athermalizing lens 200 increases, as described below in detail with respect to FIG. 4, the optical fluid 208 expands at a greater rate than the enclosure due to the higher CTE α₁. This differential expansion creates increased pressure, and may cause the membrane 202 to deform outward and increase its curvature. The resulting change in membrane curvature may alter the optical power of the lens according to the equation

$${Φ}^{′} = \frac{( n - 1 )}{{R}^{′}} ,$$

where Φ is the optical power, n is the refractive index (at the increased temperature), and R′ is the increased radius of curvature.

The athermalizing lens 200 may be configured to provide a specified rate of optical power change with temperature. In an example, the rate of optical power change with temperature may be approximately +0.005 to +0.01 diopters per degree Celsius (° C.). This positive change in optical power with increasing temperature may be specified to complement a combined negative power change of other optical elements within a larger optical system, thereby maintaining consistent optical performance for the entire optical assembly across a range of operating temperatures.

The athermalizing lens 200 as described above may operate passively, requiring no electronic control or power supply. Such passive operation may make the athermalizing lens 200 suitable for integration into compact optical systems such as augmented reality projectors where space, weight, and power constraints are significant considerations.

Note that in FIG. 2 and FIG. 3, mechanical aspects such as mounting features, fill devices and so forth are omitted for clarity.

FIG. 4 is a diagram showing principle of operation for athermalizing lens 200. The athermalizing lens 200 may provide differential thermal expansion. As noted above, the enclosure material (e.g., rigid exterior 204 and transparent element 206) has a CTE α₀, and the optical fluid 208 has a CTE α₁ that is larger than go. In an example, the optical power change may be derived as follows.

The volume of the fluid reservoir region 312 is V₀=πα²H. Let T=Θ−Θ_{ref} where Θ is the absolute temperature and Θ_{ref} is a reference temperature. Considering only the volume of optical fluid that occupies the fluid reservoir region 312, the volume change of optical fluid in the fluid reservoir region 312 is V₀(1+3α₁T). The volume change of the fluid reservoir region 312 itself is V₀(1+3α₀T). Thus, excess fluid volume is the difference between the fluid reservoir region 312 and the fluid volume is ΔV=3V₀TΔα.

The excess optical fluid 208, denoted by fluid movement 406, flows into the spherical cap 310. The volume of the spherical cap 310 can be written as

$${V}_{cap} = \frac{π {h}^{2}}{3} ( 3 R - h )$$

where h is the height of the spherical cap,

h=\sqrt{R−R²−α²}.

Since R>>α, the height may be approximated as

$$h = \frac{{a}^{2}}{2 R} ,$$

allowing the spherical cap 310 volume to be approximated as

$${V}_{cap} ≅ \frac{π {a}^{4}}{4 R} .$$

The relationship between the volume of the spherical cap 310 and the optical power of the membrane 202 is

$${V}_{c a p} = \frac{π {a}^{4}}{4 ( n - 1 )} Φ$$

Using this equation and the linear and volumetric expansion of the enclosure and fluid, the optical power at an expanded curvature 404 (where His the height of rigid exterior 204)

$$Eq \text{?} = \frac{12 ( n - 1 ) H Δ α}{{a}^{2}} \frac{T}{{( 1 + {α}_{0} T )}^{4}} + {Φ}_{0} \frac{n - 1}{{n}_{0} - 1} \frac{( 1 + 3 {α}_{1} T )}{{( 1 + {α}_{o} T )}^{4}} .$$

The analytical model above may be extended to derive a single membrane power as a function of temperature, including the boundary width and a linear expansion of the optical area radius, which may give (using α′=α−ΔR as described above):

$$\text{?} \frac{12 ( n - 1 ) H Δ α {a}^{2}}{{a}^{′ 4}} \frac{T}{{( 1 + {α}_{0} T )}^{4}} + {Φ}_{0} \frac{n - 1}{{n}_{0} - 1} \frac{( 1 + 3 {α}_{1} T )}{{( 1 + {α}_{0} T )}^{4}} .$$

The analytical model above may be further extended to consider the effect of a non-linear fluid as the optical fluid 208, which may give:

$$\text{?} \frac{( n - 1 ) H {a}^{2}}{{a}^{′ 4}} \frac{( \frac{{ρ}_{0}}{ρ} - 1 - 3 {α}_{0} T )}{{( 1 + {α}_{0} T )}^{4}} + {Φ}_{0} \frac{n - 1}{{n}_{0} - 1} \frac{{p}_{0}}{ρ} \frac{1}{{( 1 + {α}_{0} T )}^{4}} .$$

By appropriately selecting a material, the curvature increase may outweigh a refractive index decrease for multiple fluid choices. Given that dn/dT may generally be a negative quantity, the initial power Φ₀ may be selected to decrease the sensitivity of the power change to temperature. That is, in an example, a positive change of optical power may be obtained by appropriate material selection and geometry (e.g., cylinder height H, cylinder diameter 2α, initial power Φ₀, and the like).

In an example, an athermalizing lens 200 may have approximately a few millimeters clear aperture, a few hundreds of microns total thickness (including the membrane and glass disk) would give an optical power change from approximately +0.005 to +0.01 diopters per decree Celsius . . . .

FIG. 5 is a graph 500 of optical power varying with temperature, according to some examples. The graph 500 displays optical power Φ measured in diopters on the vertical axis against temperature change ΔT measured in degrees Celsius on the horizontal axis. The horizontal axis extends from 0 to 100 degrees Celsius, while the vertical axis ranges from 0 to 4 diopters.

The graph 500 presents two data series representing different methods of determining the optical power change. The first series, labeled “FEA” (Finite Element Analysis), is represented by circular markers showing discrete measurement points. The second series, labeled “predicted,” is displayed as a dotted line representing the analytical model described by Eq. 3 of optical power change with temperature.

Both data series demonstrate a linear relationship between temperature change and optical power, with the optical power increasing as temperature rises. The FEA data points closely align with the predicted curve, validating the analytical model's accuracy in predicting the thermal behavior of the athermalizing lens.

This graph serves as computational verification of the athermalizing lens 200 described above and shown in FIG. 2 to FIG. 4, demonstrating that athermalizing lens 200 provides a positive optical power change using differential thermal expansion of a refractive element (e.g., optical fluid 208) held by a fixed element (e.g., rigid exterior 204).

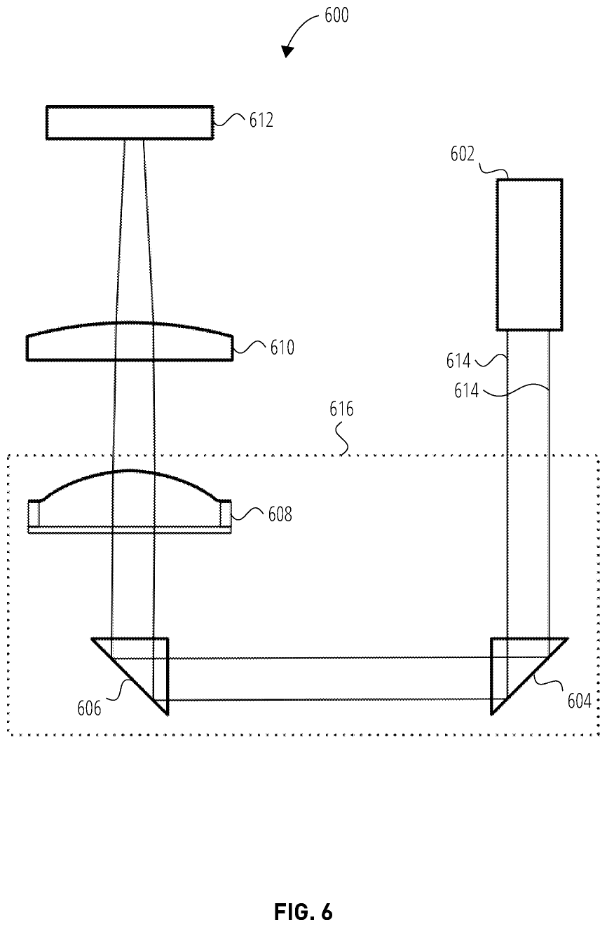

FIG. 6 is a diagram of an optical system 600 to measure the temperature performance of an athermal lens, according to some examples. The optical system 600 comprises a collimated source 602, a reflector 604, a reflector 606, an athermalizing lens 608, a reference lens 610, a detector 612, a light rays 614, and a temperature chamber 616.

In an example, a collimated source 602 may generate light rays 614 that propagate downward through the optical path. The collimated source 602 may comprise a light emitting diode (LED), laser diode, or other suitable illumination source.

In an example, the optical system 600 further includes reflectors 604 and 606 positioned to redirect the light rays 614 through athermalizing lens 608. The reflectors 604 and 606 may be mirrors, prisms, or other reflective surfaces that change the direction of the light propagation. In an example, any suitable number of reflectors 604 and 606 may be used. In an example, reflectors 604 and 606 may be omitted.

The athermalizing lens 608 may have an optical power that becomes more positive when temperature increases. The athermalizing lens 608 comprises a fluid-filled cavity bounded by a membrane, a rigid cylinder, and a transparent member, similar to the athermalizing lens 200 shown in FIG. 2 and FIG. 3. When temperature increases, the fluid within the cavity expands more than the rigid enclosure due to its higher coefficient of thermal expansion, causing the membrane to deform and increase the optical power of the lens.

In an example, a temperature chamber 616 may be used to enclose any of the optical components in optical system 600, such as the reflectors 604 and 606 and the athermalizing lens 608. In an example, the temperature chamber 616 may provide a controlled environment for testing the thermal performance of the athermalizing lens 608. That is, in an example, the temperature chamber 616 may allow for controllable temperature variation to evaluate how the athermalizing lens 608 compensates for thermal effects in the other optical elements.

In an example, the reference lens 610 may be positioned outside of the temperature chamber 616. In an example, the reference lens 610 may be any suitable lens or optical system (e.g., microscope objective, etc.) with a known optical power. A detector 612 may be positioned to receive the light rays 614. The detector 612 may be used to measure and verify the optical performance of the system across different temperatures. In an example, the detector 612 may be moveable. For example, the detector 612 may be positioned at a first location where the light rays 614 converge to a focal point. By measuring the position of the detector at this focal point, with the known power of the reference lens 610, an optical power of the athermalizing lens 608 may be determined. The temperature chamber 616 may be adjusted to a different temperature (e.g., a higher temperature), and the detector 612 may be re-positioned to another location corresponding to a shift in the focal point of the optical system 600. In this example, the shift of the focal point may be due to the expansion of the athermalizing lens 608, and a corresponding change in optical power of the athermalizing lens 608 may be determined.

In an example, the reference lens 610 may be positioned inside the temperature chamber 616. In an example, when a general change in optical power of the athermalizing lens 608 with temperature is determined, the reference lens 610 may be combined with the athermalizing lens 608 to evaluate the optical power change for the combination of reference lens 610 and athermalizing lens 608. In an example, reference lens 610 may be a lens that is deployed in a target application (e.g., augmented reality headset, satellite optical system, heads-up display, telescope optical system).

The optical system 600 operates as a complete system where the athermalizing lens 608 provides passive thermal compensation without requiring electronic control or power. As the temperature of the system increases, the athermalizing lens 608 develops increased positive optical power that complements the negative power changes in other components, thereby maintaining consistent optical performance across the operating temperature range.

This implementation enables the use of plastic optical elements in applications where thermal stability is required, such as in augmented reality projectors. By incorporating the athermalizing lens 608 that provides +0.005 to +0.01 diopters per ° C. of positive power change, the optical system can compensate for the −0.005 to −0.01 diopters per ° C. negative power change typically observed in plastic optical systems, providing up to 0.25 diopters of compensation across a 25° C. temperature range.

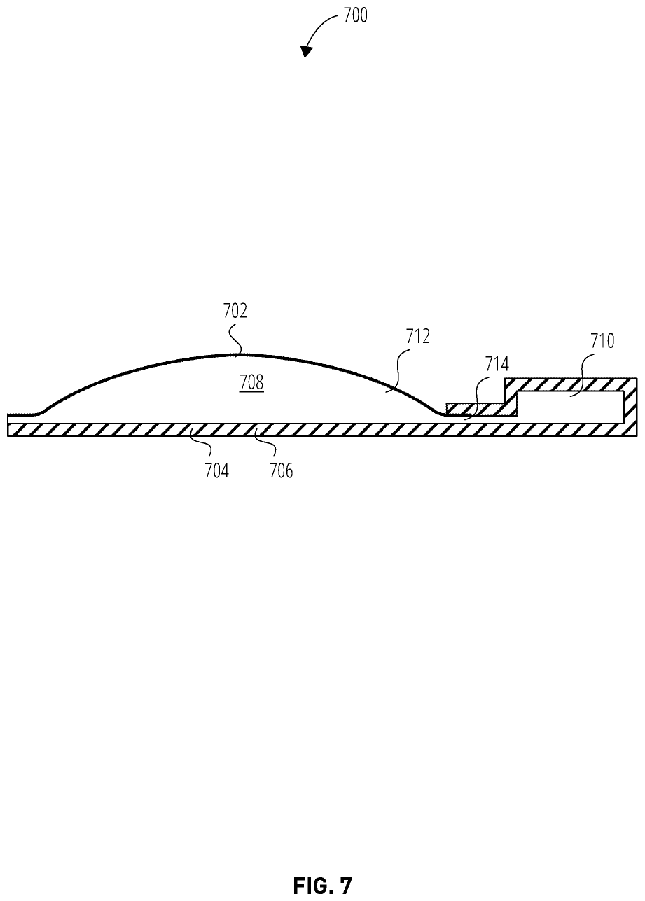

FIG. 7 is diagram of another membrane-based athermalizing lens, according to some examples. The athermalizing lens 700 comprises a membrane 702, a rigid exterior 704, a transparent element 706, an optical fluid 708, a fluid reservoir region 710, a fluid spherical cap region 712, and a fluid connection 714. The athermalizing lens 700 may be substantially similar to the athermalizing lens 200. As shown in FIG. 7, the fluid reservoir region 710 may be away from the clear aperture of the lens.

In an example, rigid exterior 704 may provide a fluid reservoir region 710 positioned alongside a fluid spherical cap region 712 formed by the membrane 702. That is, one of the fluid volumes may be a substantially fluid spherical cap region 712 bounded by the membrane 202, and the second fluid volume may be a fluid reservoir region 710 bounded by rigid exterior 204.

The fluid spherical cap region 712 and fluid reservoir region 710 may be in fluid contact as denoted by fluid connection 714 which in the example of FIG. 7 may be a thin channel connecting the fluid spherical cap region 712 to the fluid reservoir region 710. Note that FIG. 7 may not be to scale and is given principally to show the concept of the two fluid volumes where a reservoir volume is away from the clear aperture of the lens. Any suitable geometric arrangement of fluid reservoir region 710 and fluid spherical cap region 712 may be provided, such as wherein the fluid reservoir region 710 is an annular section around the fluid spherical cap region 712, etc.

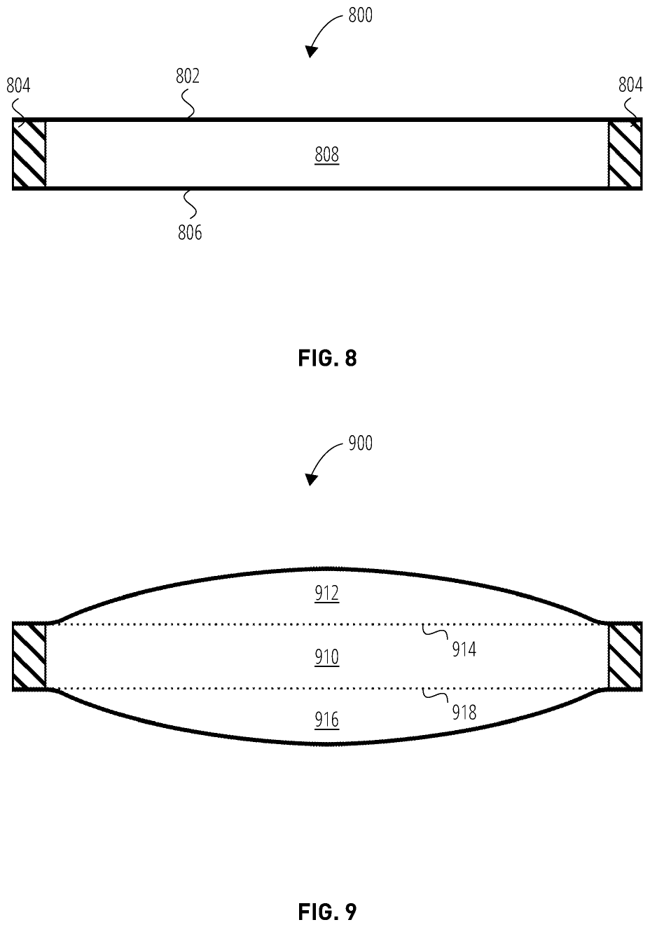

FIG. 8 is a diagram of a double sided membrane athermalizing lens 800, according to some examples. The athermalizing lens 800 comprises a membrane 802, a rigid exterior 804, a membrane 806, and an optical fluid 808.

In a double sided membrane such as athermalizing lens 800, the volume change of the optical fluid 808 may go into two equal spherical caps, as shown in FIG. 9 in the expanded athermalizing lens 900. The volume of the fluid reservoir region 910 of the enclosure has expanded by the CTE of the enclosure material, and the volume of the fluid spherical cap region 912 and fluid spherical cap region 916 both have a new radius of curvature. Similar to the athermalizing lens 200, the double sided membrane athermalizing lens 800 works principally by differential thermal expansion between the optical fluid 808 and rigid exterior 804.

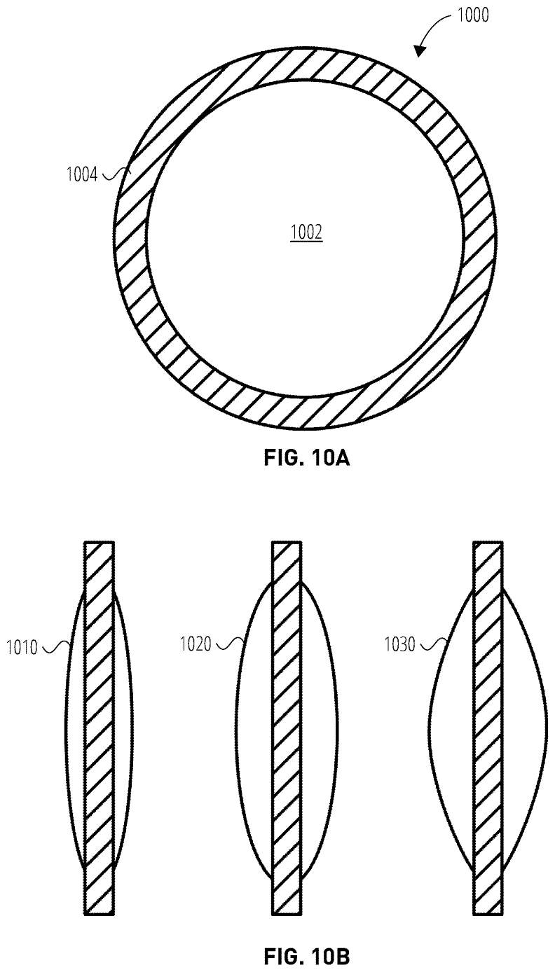

FIG. 10A is a diagram of side view of a diagram of an athermalizing lens 1000 using a constrained lens. The athermalizing lens 1000 comprises a constrained lens 1002 and a rigid exterior 1004. In an example, athermalizing lens 1000 may be an embodiment of an athermalizing lens that expands.

The constrained lens 1002 may be a high CTE/low modulus (e.g. polymer) lens, which may be held by a low CTE/high modulus (e.g. metal) rigid exterior 1004. As the temperature increases, the constrained lens 1002 expands more than the rigid exterior 1004, hence increasing in optical power.

In an example, the rigid exterior 1004 may comprise an orthotropic collar where the CTE of the collar is large in the direction of the optical axis and small in the hoop direction. This may be achieved using a composite material such as carbon fiber reinforced plastic (CRP) where the fibers are oriented in the hoop direction and are embedded in a high-CTE polymer matrix. In another example, this may be achieved using a metal bellows shape to the rigid exterior 1004.

FIG. 10B is a side view of a diagram of an athermalizing lens 1000 using a constrained lens at varying temperatures, according to some examples. The athermalizing lens 1000 comprises a reference shape 1010, an expanded lens 1020, and a further expanded lens 1030.

In an example, the athermalizing lens 1000 may have an initial curvature c to the upper surface, as shown by reference shape 1010. In an example, the reference shape 1010 may be a biconvex lens with a metal band around the middle. The surface form of the upper surface of reference shape 1010 at ambient temperature is assumed to be near enough

$${z}_{0} = {a}_{0} - \frac{c {r}^{2}}{2} .$$

To a first order of approximation, the metal band constrains the lens in r but leaves it free to expand in z.

In an example, the initial curvature of the reference shape 1010 may be determined such that a specified rate of change of power with temperature may be achieved. That is, in an example, the expanded lens 1020 may have a first expanded curvature that, at a given first temperature, may compensate for changes to optical power of other optical elements in a specified optical system. Continuing this example, the further expanded lens 1030 may have a further expanded curvature that, at a given higher temperature, may further compensate for changes to optical power of other optical elements in the specified optical system.

In an example, the initial curvature of the reference shape 1010 may be modeled so that at temperature T=Θ−Θ_{ref} relative to a reference temperature (where the absolute temperature is Θ, and Θ_{ref} is a reference temperature), the surface form is (where αᵢₙ is the CTE of the constrained lens 1002):

$$z ( T ) = {z}_{0} ( 1 + {α}_{i n} T ) = {a}_{0} ( 1 + {α}_{i n} T ) - \frac{c {r}^{2}}{2} ( 1 + {α}_{i n} T )$$

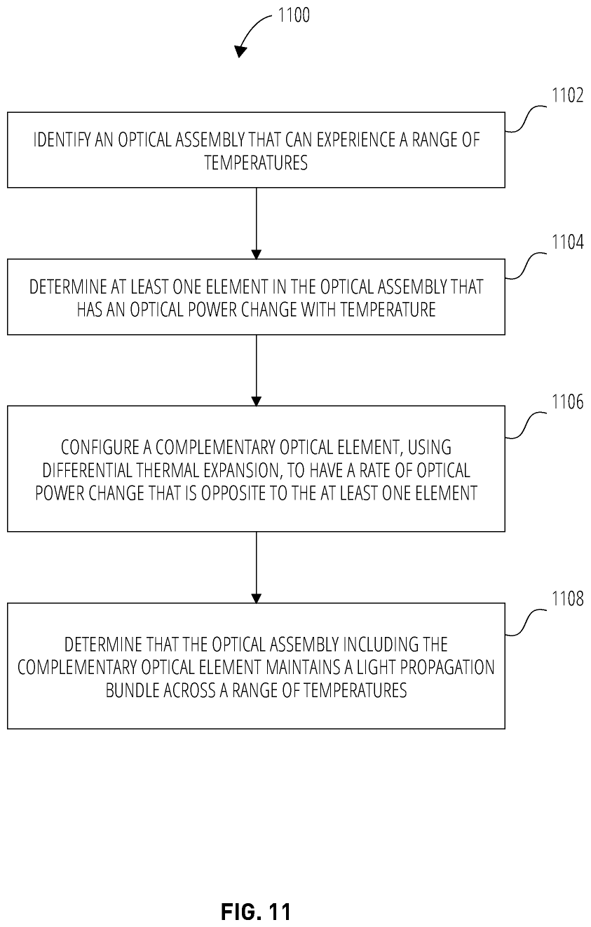

FIG. 11 is a flowchart showing operations of an example method 1100 for an athermalizing lens, according to some examples. Although the example routine depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence.

At block 1102, an optical assembly that can experience a range of temperatures is identified. This operation may comprise analyzing the intended operating environment of an optical system. In an example, an athermalizing lens may be integrated into augmented reality (AR) headsets to maintain consistent optical performance across varying environmental temperatures. In an example, satellite optical systems may experience extreme temperature variations during a mission, and an athermalizing lens may be deployed to help with reduction of size, weight, and power of an optical assembly. In an example, automotive (or other vehicular) heads-up displays may present significant temperature variations such as sub-zero winter temperatures to extreme heat in summer, and an athermalizing lens may present a durable solution for maintaining a consistent image projection onto a vehicle windshield or windscreen (such as for an aerospace vehicle). In an example, a medical imaging device may require precise optical performance across various operating environments such as a cold storage environment to a warm operating room. In an example, an underwater optical system may experience rapid temperature changes when moving between different water depths or regions. In an example, astronomic telescopes may operate in varying nighttime temperatures and may require precise optical performance to provide accurate cosmic observations. Multiple athermalizing lenses may be distributed throughout the optical path of a telescope to provide localized compensation in a larger optical system.

The analytical relationship between temperature change and optical power change demonstrated in FIG. 5 allows for a variety of optical assemblies to use an athermalizing lens such as shown in FIG. 2, FIG. 7, FIG. 8, and FIG. 10A. The identification process may include determining the expected temperature range the optical assembly may encounter during normal operation, which may span from an ambient temperature to 25 degrees C. above the ambient temperature.

At block 1104, at least one element in the optical assembly that has an optical power change with temperature is determined. This operation may comprise analyzing the thermal behavior of optical components and optomechanical components (e.g., hardware for mounting or holding the optical components that may also experience temperature changes) within the assembly, particularly focusing on elements made from materials such as plastic that typically exhibit larger CTE and larger thermo-optic coefficients than glass. The analysis may quantify the rate at which optical power decreases with increasing temperature, which may be in the range of −0.005 to −0.01 diopters per degree C. for plastic optical elements.

At block 1106, a complementary optical element may be configured, using differential thermal expansion, to have a rate of optical power change is opposite to the at least one element. This operation may involve designing an expanding lens with specified materials and geometry to achieve a positive optical power change with temperature. The expanding lens may utilize differential thermal expansion between components, such as a fluid with a larger CTE contained within an enclosure of lower thermal expansion. The design process may include selecting appropriate materials and determining a specified geometry that achieves an optical power change rate (e.g., optical power change with temperature) that complements the optical power change rate in the other optical elements of the optical assembly.

At block 1108, a determination may be made that the optical assembly including the complementary optical element maintains a light propagation bundle across a range of temperatures. This operation may involve testing or simulating the combined optical assembly to verify that the expanding lens effectively compensates for thermal effects in the other components. The verification may confirm that the focal length and other optical parameters (e.g., field of view, clear aperture, etc.) remain stable across temperature variations, ensuring consistent optical performance across the operating temperature range. The determination may include finite element analysis (FEA) simulations to predict the optical behavior, as well as physical testing of optical assemblies.

The method 1100 may allow for the use of plastic optical elements in applications where thermal stability is required, such as in compact projectors for augmented reality devices. The method may implement passive thermal compensation through an expanding lens to maintain optical performance across varying thermal conditions.

To further illustrate the systems and related methods disclosed herein, a non-limiting list of examples is provided below. Each of the following non-limiting examples may stand on its own or may be combined in any permutation or combination with any one or more of the other examples.

Example 1 is a passively athermalized optical assembly comprising: an expanding lens having an optical power that becomes more positive when a temperature of the optical assembly increases from a first temperature to a second temperature.

In Example 2, the subject matter of Example 1 includes, wherein the more positive optical power of the expanding lens complements changes in other components of the optical assembly such that an outgoing light bundle maintains a propagation trajectory when the temperature of the optical assembly changes from the first temperature to the second temperature.

In Example 3, the subject matter of Example 2 includes, wherein the other components comprise at least one additional lens made from a material that causes an optical power of the at least one additional lens to weaken when the temperature of the optical assembly increases.

In Example 4, the subject matter of Examples 1-3 includes, wherein: the expanding lens comprises an enclosure and a refractive element held in the enclosure; and a coefficient of thermal expansion (CTE) of the refractive element is larger than a CTE of the enclosure.

In Example 5, the subject matter of Example 4 includes, wherein the refractive element comprises a fluid-filled cavity bounded by at least one membrane.

In Example 6, the subject matter of Example 5 includes, a fluid reservoir adjoining the fluid-filled cavity; wherein, when the temperature of the optical assembly increases, fluid in the reservoir expands into the fluid-filled cavity, thereby causing the at least one membrane to deform such that the optical power of the expanding lens becomes more positive.

In Example 7, the subject matter of Example 6 includes, wherein the enclosure comprises a rigid cylinder and a transparent member, the membrane joined to the rigid cylinder such that the fluid-filled cavity is bounded by the membrane, the rigid cylinder, and the transparent member.

In Example 8, the subject matter of Example 7 includes, wherein the fluid-filled cavity comprises two fluid volumes: a first fluid volume comprising a spherical cap bounded by the membrane; and a second fluid volume comprising the fluid in the fluid reservoir, the second fluid volume bounded by the rigid cylinder and the transparent member, wherein the fluid reservoir is continuous with the first fluid volume.

In Example 9, the subject matter of Examples 6-8 includes, wherein the enclosure comprises a transparent member and the fluid-filled cavity is bounded by the membrane and the transparent member.

In Example 10, the subject matter of Example 9 includes, wherein the fluid reservoir is positioned such that the fluid reservoir is outside an optical aperture of the expanding lens, wherein the fluid reservoir is connected to the fluid-filled cavity through a fluid channel.

In Example 11, the subject matter of Examples 5-10 includes, wherein: the fluid-filled cavity is further bounded by a second membrane; the enclosure comprises a rigid cylinder; the fluid-filled cavity comprises three connected fluid volumes, a first fluid volume comprising a spherical cap bounded by the membrane, a second fluid volume comprising a cylindrical region bounded by the rigid cylinder, and a third fluid volume comprising a spherical cap bounded by the second membrane, the second fluid volume further continuous with the first fluid volume and the third fluid volume; and when the temperature of the optical assembly increases, the second fluid volume expands into the first fluid volume and the third fluid volume, thereby causing the membrane and the second membrane to deform such that the optical power of the expanding lens becomes more positive.

In Example 12, the subject matter of Examples 4-11 includes, wherein a stiffness of the enclosure is larger than a stiffness of the refractive element.

In Example 13, the subject matter of Example 12 includes, wherein: the refractive element comprises a biconvex lens; when the temperature of the optical assembly increases, expansion of the refractive element is constrained by the enclosure; and constraining the refractive element by the enclosure causes a change in a radius of curvature in the biconvex lens such that the optical power of the expanding lens becomes more positive.

In Example 14, the subject matter of Examples 2-13 includes, diopters per °-Celsius.

In Example 15, the subject matter of Examples 2-14 includes, wherein the optical assembly projects light received from a light source.

Example 16 is a method of passively athermalizing an optical assembly, the method comprising: projecting light through the optical assembly to form a light bundle having a propagation trajectory, the optical assembly comprising an expanding lens; in response to an increase in a temperature of the optical assembly, making an optical power of the expanding lens more positive.

In Example 17, the subject matter of Example 16 includes, wherein the more positive optical power of the expanding lens complements changes in other components of the optical assembly, such that the light bundle maintains the propagation trajectory.

In Example 18, the subject matter of Examples 16-17 includes, wherein: the expanding lens comprises an enclosure and a refractive element held in the enclosure; and a coefficient of thermal expansion (CTE) of the refractive element is larger than a CTE of the enclosure.

In Example 19, the subject matter of Example 18 includes, wherein the refractive element comprises a fluid-filled cavity bounded by at least one membrane, the expanding lens further comprising a fluid reservoir adjoining the fluid-filled cavity; wherein, when the temperature of the optical assembly increases, fluid in the reservoir expands into the fluid-filled cavity, thereby causing the at least one membrane to deform such that the optical power of the expanding lens becomes more positive.

In Example 20, the subject matter of Example 19 includes, wherein the fluid-filled cavity comprises two connected fluid volumes: a first fluid volume comprising a spherical cap bounded by the membrane; and a second fluid volume comprising a cylindrical region bounded by a rigid cylinder and a transparent member, wherein the second fluid volume is continuous with the first fluid volume.

Example 21 is a lens having an optical power that becomes more positive when a temperature of the lens increases.

Example 22 is a projector assembly comprising: a light source; and a passively athermalized optical assembly that receives light from the light source, the passively athermalized optical assembly comprising: a first lens comprising a plastic lens having an optical power that weakens when a temperature of the optical assembly increases from a first temperature to a second temperature; and an expanding lens comprising a fluid-filled cavity bounded by a membrane, a rigid cylinder, and a transparent member; the membrane mechanically secured to the rigid cylinder, the rigid cylinder covered with the transparent member on a side opposite to the membrane, the fluid-filled cavity comprising two connected fluid volumes: a first fluid volume comprising a spherical cap bounded by the membrane; and a second fluid volume comprising a cylindrical region bounded by the rigid cylinder and the transparent member, the second fluid volume further continuous with the spherical cap and within a clear aperture of the optical assembly; and when the temperature of the optical assembly increases from the first temperature to the second temperature: the second fluid volume expands into the spherical cap thereby causing the membrane to have a different radius of curvature such that the optical power of the expanding lens becomes more positive, such that an outgoing light bundle generated by the passively athermalized optical assembly maintains a propagation trajectory.

Example 23 is a method of manufacturing a passively athermalizing optical assembly, the method comprising: measuring a change of optical power of an optical assembly as a temperature of the optical assembly is increased; determining an optical power change that can compensate the measured change; configuring an expanding lens that has the determined optical power change to compensate the measured change, wherein the expanding lens comprises an enclosure and a refractive element held in the enclosure, further wherein a coefficient of thermal expansion (CTE) of the refractive element is larger than a CTE of the enclosure; and assembling the expanding lens and the optical assembly into a combined assembly such that an outgoing light bundle from the combined assembly maintains a propagation trajectory when the temperature of the combined optical assembly changes.

Example 24 is at least one machine-readable medium including instructions that, when executed by processing circuitry, cause the processing circuitry to perform operations to implement any of Examples 1-23.

Example 25 is an apparatus comprising means to implement any of Examples 1-23.

Example 26 is a system to implement any of Examples 1-23.

Example 27 is a method to implement any of Examples 1-23.

What is claimed is:

1. A passively athermalized optical assembly comprising:
an expanding lens having an optical power that becomes more positive when a temperature of the optical assembly increases from a first temperature to a second temperature.

2. The optical assembly of claim 1, wherein the more positive optical power of the expanding lens complements changes in other components of the optical assembly such that an outgoing light bundle maintains a propagation trajectory when the temperature of the optical assembly changes from the first temperature to the second temperature.

3. The optical assembly of claim 2, wherein the other components comprise at least one additional lens made from a material that causes an optical power of the at least one additional lens to weaken when the temperature of the optical assembly increases.

4. The optical assembly of claim 1, wherein:
the expanding lens comprises an enclosure and a refractive element held in the enclosure; and
a coefficient of thermal expansion (CTE) of the refractive element is larger than a CTE of the enclosure.

5. The optical assembly of claim 4, wherein the refractive element comprises a fluid-filled cavity bounded by at least one membrane.

6. The optical assembly of claim 5,
further comprising a fluid reservoir adjoining the fluid-filled cavity;
wherein, when the temperature of the optical assembly increases, fluid in the reservoir expands into the fluid-filled cavity, thereby causing the at least one membrane to deform such that the optical power of the expanding lens becomes more positive.

7. The optical assembly of claim 6, wherein the enclosure comprises a rigid cylinder and a transparent member, the membrane joined to the rigid cylinder such that the fluid-filled cavity is bounded by the membrane, the rigid cylinder, and the transparent member.

8. The optical assembly of claim 7, wherein the fluid-filled cavity comprises two fluid volumes:
a first fluid volume comprising a spherical cap bounded by the membrane; and
a second fluid volume comprising the fluid in the fluid reservoir, the second fluid volume bounded by the rigid cylinder and the transparent member, wherein the fluid reservoir is continuous with the first fluid volume.

9. The optical assembly of claim 6, wherein the enclosure comprises a transparent member and the fluid-filled cavity is bounded by the membrane and the transparent member.

10. The optical assembly of claim 9, wherein the fluid reservoir is positioned such that the fluid reservoir is outside an optical aperture of the expanding lens, wherein the fluid reservoir is connected to the fluid-filled cavity through a fluid channel.

11. The optical assembly of claim 5, wherein:
the fluid-filled cavity is further bounded by a second membrane;
the enclosure comprises a rigid cylinder;
the fluid-filled cavity comprises three connected fluid volumes, a first fluid volume comprising a spherical cap bounded by the membrane, a second fluid volume comprising a cylindrical region bounded by the rigid cylinder, and a third fluid volume comprising a spherical cap bounded by the second membrane, the second fluid volume further continuous with the first fluid volume and the third fluid volume; and
when the temperature of the optical assembly increases, the second fluid volume expands into the first fluid volume and the third fluid volume, thereby causing the membrane and the second membrane to deform such that the optical power of the expanding lens becomes more positive.

12. The optical assembly of claim 4, wherein a stiffness of the enclosure is larger than a stiffness of the refractive element.

13. The optical assembly of claim 12, wherein:
the refractive element comprises a biconvex lens;
when the temperature of the optical assembly increases, expansion of the refractive element is constrained by the enclosure; and
constraining the refractive element by the enclosure causes a change in a radius of curvature in the biconvex lens such that the optical power of the expanding lens becomes more positive.

14. The optical assembly of claim 2, wherein the optical power of the expanding lens varies up to 0.25 diopters across a temperature change of up to 25 degrees Celsius from ambient temperature, wherein a rate of change in the optical power is approximately 0.01 diopters per degree Celsius.

15. A method of passively athermalizing an optical assembly, the method comprising:
projecting light through the optical assembly to form a light bundle having a propagation trajectory, the optical assembly comprising an expanding lens; and
in response to an increase in a temperature of the optical assembly, making an optical power of the expanding lens more positive.

16. The method of claim 15, wherein the more positive optical power of the expanding lens complements changes in other components of the optical assembly, such that the light bundle maintains the propagation trajectory.

17. The method of claim 15, wherein:
the expanding lens comprises an enclosure and a refractive element held in the enclosure; and
a coefficient of thermal expansion (CTE) of the refractive element is larger than a CTE of the enclosure.

18. The method of claim 17, wherein the refractive element comprises a fluid-filled cavity bounded by at least one membrane, the expanding lens further comprising a fluid reservoir adjoining the fluid-filled cavity; wherein, when the temperature of the optical assembly increases, fluid in the reservoir expands into the fluid-filled cavity, thereby causing the at least one membrane to deform such that the optical power of the expanding lens becomes more positive.

19. The method of claim 18, wherein the fluid-filled cavity comprises two connected fluid volumes:
a first fluid volume comprising a spherical cap bounded by the membrane; and
a second fluid volume comprising a cylindrical region bounded by a rigid cylinder and a transparent member, wherein the second fluid volume is continuous with the first fluid volume.

20. A projector assembly comprising:
a light source; and
a passively athermalized optical assembly that receives light from the light source, the passively athermalized optical assembly comprising:
a first lens comprising a plastic lens having an optical power that weakens when a temperature of the optical assembly increases from a first temperature to a second temperature; and
an expanding lens comprising a fluid-filled cavity bounded by a membrane, a rigid cylinder, and a transparent member;
the membrane mechanically secured to the rigid cylinder, the rigid cylinder covered with the transparent member on a side opposite to the membrane, the fluid-filled cavity comprising two connected fluid volumes:
a first fluid volume comprising a spherical cap bounded by the membrane; and
a second fluid volume comprising a cylindrical region bounded by the rigid cylinder and the transparent member, the second fluid volume further continuous with the spherical cap and within a clear aperture of the optical assembly; and
when the temperature of the optical assembly increases from the first temperature to the second temperature:
the second fluid volume expands into the spherical cap thereby causing the membrane to have a different radius of curvature such that the optical power of the expanding lens becomes more positive, such that an outgoing light bundle generated by the passively athermalized optical assembly maintains a propagation trajectory.
